(19) United States
(12) Patent Application Publication
(10) Pub. No.: US 2026/0139936 A1
(43) Pub. Date: May 21, 2026

(54) PROJECTILE WITH AN OBTURATOR RING, METHOD FOR MANUFACTURING AND METHOD FOR ARRANGEMENT OF AN OBTURATOR RING

(71) Applicant: BAE SYSTEMS BOFORS AB, SE-69180 Karlskoga (SE)

(72) Inventors: Christer THUMAN, Karlskoga (SE); Hamzah HAMDAN, Karlskoga (SE); Björn JOHANSSON, Karlskoga (SE)

(73) Assignee: BAE SYSTEMS BOFORS AB, SE-69180 Karlskoga (SE)

(21) Appl. No.: 19/128,220

(22) PCT Filed: Oct. 12, 2023
(86) PCT No.: PCT/SE2023/051019

§ 371 Date: May 8, 2025

(30) Foreign Application Priority Data
Nov. 11, 2022 (SE) 2200129-1

(51) Int. Cl. F42B 14/02; F42B 33/00

(52) U.S. Cl. CPC F42B 14/02; F42B 33/00

(57) ABSTRACT

A projectile including with an obturator ring and intended to be fired from a weapon system with a barrel, where the obturator ring is arranged with at least one obturator segment arranged with at least one slot, where at least one obturator segment is held together and retained in the projectile by means of an annular gasket attached to at least one obturator segment.

### BACKGROUND AND SUMMARY

The present invention concerns a projectile outfitted with an obturator which is intended to be fired from a weapons system. Additionally, the invention concerns a process for manufacturing an obturator as well as a process for arrangement of an obturator on a projectile.

An obturator, also known as a belt, is used in projectiles fired from barrels to provide both a gas seal between the projectile and the barrel as well as effective friction coupling against the barrel in the event that rotation of the projectile is desired. The term belt is often used for projectiles fired from rifled barrels. Traditionally, projectiles are rotationally stabilized in order to achieve better aerodynamic properties by causing the projectile to rotate during the firing process as a result of rifling in the barrel. When the projectile outfitted with a belt is propelled out of the barrel, the belt is partially deformed by the rifling and thus the belt grips the rifling and rotates the projectile in a manner corresponding to the pitch of the rifling. If a steerable projectile is desired, it is advisable that the projectile is roll-stable, that is, not rotating, when the fins are folded out and employed. As it is desirable to use the same barrel, and thus the same launch device, for all projectiles, the construction of the steerable projectiles includes a sliding belt which allows them to be fired from a grooved barrel. The sliding belt of the steerable projectile engages the rifling in the barrel and creates a gas seal. As the projectile is propelled into the barrel, the belt rotates with the pitch of the rifling. The connection between the belt and the projectile is such that the friction is low and a slip or slide against the projectile occurs, which means that the projectile either does not rotate or rotates with a significantly smaller rotation than in cases where a fixed mounted belt is used. As the projectile exits the barrel, the projectile rotation will be low. In addition to the advantage that steerable projectiles are roll-stable, a low rotation in the barrel is important for reducing the forces arising from the angular acceleration to which the electronics and mechanics mounted in the projectile are exposed during launch.

The term obturator is often used for projectiles fired from muzzle-loaded grenade launchers, as the purpose of the obturator ring is to seal against the barrel when the projectile is fired, but at the same time enable the projectile to be loaded into the barrel so as to avoid the obturator ring being arranged/creating friction against the barrel and to allow for the evacuation of any air present in the barrel. The obturator ring is not deformed by the barrel but expands during ejection so that a seal between projectile and barrel is created and enables the projectile to be propelled out of the barrel by gunpowder gases.

Patent document U.S. Pat. No. 6,419,235 B1 discloses an invention showing a segmented obturator ring consisting of or comprising two parts arranged to expand the propellant gases during firing, and which is completely separated from the projectile after the projectile leaves the barrel. The patent does not show the obturator ring being arranged with any retaining device, such as an O-ring.

Patent document WO 2007/106009 A1 discloses a belt provided with an O-ring that functions as a seal and holding element. The patent document does not demonstrate any segmented obturator ring.

The above prior art does not solve problems related to designing an obturator ring that effectively seals the propellant gases during firing, while ambient air is allowed to pass through the projectile during loading and contributes to low dispersion in V0, where a resilient element is well-protected in the obturator ring and where the obturator ring has a low profile and is arranged in a shallow obturator groove on the projectile, which results in the projectile becoming more durable, as a relatively small amount of the projectile's material is processed to enable the obturator groove.

Additional problems which the present invention seeks to solve will become apparent in connection with the following detailed description of the various embodiments.

The aforementioned problem can be addressed by designing the obturator ring as obturator segments equipped with a slot, where a protected annular gasket enabling the expansion of the obturator segments is arranged.

The invention, according to an aspect thereof, comprises a projectile, outfitted with an obturator ring, designed to be fired from a weapon system with a barrel, where the obturator ring incorporates at least one obturator segment arranged with at least one slot, and where the obturator segments are held together and retained in the projectile by means of an annular gasket attached to at least one obturator segment.

According to further aspects for projectile, arranged with obturator ring, the following applies as per the invention:
the obturator segments are arranged with a groove adapted for an annular gasket and at least two locking elements are arranged so as to retain the annular gasket in the groove.
the groove is arranged on a rear short side of the obturator segment where the annular gasket is arranged.
the slot(s) on the obturator segments partially overlap(s) due to conically designed contact geometry on the slot where a first contact geometry aligns with a second contact geometry.
the obturator ring consists of or comprises two obturator segments.
the annular gasket is an O-ring made out of a polymer.
the annular gasket is an annular tension spring made out of metal.

In addition, the invention, according to an aspect thereof, comprises a method for manufacturing an obturator ring comprised of at least one obturator segment with at least one slot, where
i.) obturator segments are arranged in a ring shape,
ii.) an annular gasket is arranged in a groove arranged in obturator segments where obturator segments individually or together form an obturator ring,
iii.) a locking member is hot formed on the obturator segment to retain the annular gasket in the obturator segment.

According to further aspects for the method of manufacturing an obturator ring according to the invention, the following applies:
obturator segments are arranged on a hot forming station to form locking elements.

Furthermore, the invention, according to an aspect thereof, comprises a method for arranging an obturator ring comprising a number of obturator segments arranged with an annular gasket on a projectile, characterized in that;
i.) the obturator ring is arranged on a fixture,
ii.) A fixture with an obturator ring is arranged on projectile,
iii.) the obturator ring is removed from the fixture in a groove arranged on the projectile.

Existing obturator/obturator ring design solutions do not combine an outward-springing function with a retaining element in the form of an annular gasket that enables easy attachment of the obturator ring to the projectile. The annular gasket ensures that the obturator ring remains attached to the projectile during storage and transport. It also provides a suitable resilient effect when the obturator ring expands against the barrel during firing.

The obturator ring effectively seals the gunpowder gases, and expands upon firing, since gunpowder gases cause the expansion of obturator ring. Additionally, the obturator ring, being in a non-expanded state around the projectile during loading, allows ambient air to flow past the projectile during loading. The controlled and repeatable function of the obturator ring results in low variation in V0—that is, the low variation in ejection velocity—directly enhancing the ejection's precision. Furthermore, the resilient element, the annular gasket, is well protected in the obturator ring. Since the obturator ring has a low profile, a relatively low obturator groove can be arranged in the projectile at the same time that the obturator ring has a low profile, which results in a low impact on the aerodynamics of the projectile after launch, and that the belt groove has a low profile and thus low impact on the strength of the projectile.

After ejection, whether the obturator ring detaches from or remains on the projectile depends on the choice of annular gasket and other design considerations.

### BRIEF DESCRIPTION OF THE DRAWINGS

The invention will be described below by reference to the figures that are included there:

FIG. 1 shows an obturator according to an embodiment of the invention.

FIG. 2 shows a detail of an obturator segment of an obturator according to an embodiment of the invention.

FIG. 3 shows a detail of an obturator segment of an obturator according to an embodiment of the invention.

FIG. 4 shows a detail of an obturator segment of an obturator according to an embodiment of the invention.

FIG. 5 shows a projectile outfitted with an obturator according to an embodiment of the invention.

FIG. 6 shows part of an obturator segment according to an embodiment of the invention.

### DETAILED DESCRIPTION

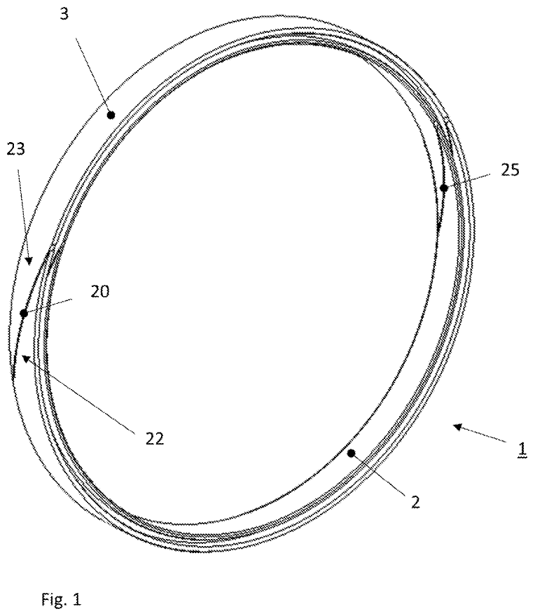

FIG. 1 shows obturator ring 1 in an embodiment that has two obturator segments, a first obturator segment 2 and a second obturator segment 3. The material in both the first obturator segment 2 and the second obturator segment 3 is preferably a dimensionally stable material such as a polymer, for example POM or PEEK. In order to avoid wear on the barrel during ejection, it is advisable that the selected material is not too hard, which is why, for example, various forms of polymers are suitable as materials in the obturator segments 2, 3. Additionally, the obturator ring creates a seal against the barrel, ensuring that gases produced by the propellant charge during firing do not leak around the projectile. Mainly, most of the gas pressure must be created and maintained behind the projectile. Thus, the chosen material for the obturator ring must be able to create a seal against the gas created by the propellant charge and be able to handle both the pressure increase and the temperature increase that occurs. The seal is achieved partially by the choice of material for the obturator ring but primarily by its design, which allows the obturator ring to expand upon firing and seal against the barrel.

In a first embodiment, the obturator ring 1 is made out of an obturator segment arranged as a ring, with a slot 20 arranged on the ring, which enables the ring to expand. The presence of slot 20 means that the obturator ring 1 is broken, rather than a continuous ring, and thus constitutes an annular segment where the corresponding short sides of the segment align with each other in a contact geometry so that a first contact geometry 22 on the obturator segment aligns with a second contact geometry 23 on the obturator segment.

In an alternative embodiment, the obturator ring is manufactured from two obturator segments 2, 3 which are arranged to each other to jointly form a ring. An obturator ring 1 arranged with two segments 2, 3 thus has two slots, a first slot and a second slot. Preferably, the corresponding obturator segments are the same size. The corresponding segments are preferably arranged so that a certain overlap occurs between the segments when the segments are arranged together, for example by each segment having a conical design so that each segment creates a conically shaped contact geometry on slot 20. Specifically, in cases where the obturator ring 1 consists of or comprises two segments, a first obturator segment 2 and a second obturator segment 3, the first obturator segment 2, for the first slot, is provided with a first contact geometry 22. This first contact geometry 22 aligns with a second contact geometry 23 on the second obturator segment 3. A corresponding contact geometry results for the second slot 25.

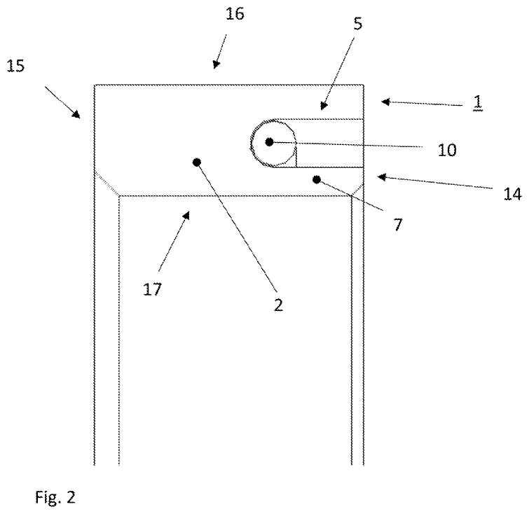

FIG. 2 shows an obturator segment of the obturator ring in detail. In the figure the first obturator segment 2 is shown but the second obturator segment 3, or other additional obturator segments in cases where the obturator ring consists of or comprises more than two obturator segments, is similarly designed as the first obturator segment 2. The figure shows how an annular gasket 10 is arranged in all obturator segments included in the obturator ring and connects all obturator segments into a unit in the event that more than one obturator segment is used for an obturator ring. In a first embodiment, the obturator ring 1 is arranged by an obturator segment. In a second embodiment, the obturator ring is outfitted with two obturator segments, a first obturator segment 2 and a second obturator segment 3, but the obturator ring can also be arranged with another number of obturator segments such as 3, 4, 5, 6 or more obturator segments. The annular gasket may be an O-ring made out of a polymer such as nitrile or other conventional materials for manufacturing O-rings that provide a suitable combination of strength and flexibility and ability to be stored or otherwise maintain good physical performance over time. The annular gasket can also be a tension spring, for example made out of steel or a polymer. The annular gasket 10 is arranged in a groove 5 which is arranged in the corresponding obturator segment, and which is adapted to receive an annular gasket of a suitable dimension. When the annular gasket is arranged in groove 5, a locking element 7 can be deformed so that it retains the annular gasket 10 in groove 5 and thereby jointly arranges all included obturator segments. In a second embodiment, the first obturator segment 2 and the second obturator segment 3 are coordinated into an obturator ring consisting of or comprising the sub-components, a first obturator segment 2, a second obturator segment 3 and an annular gasket 10. Each obturator segment is outfitted with a number of locking elements 7 which can be deformed and retain the annular gasket, whereas each obturator segment is preferably arranged with at least one locking element 7 and preferably at least three locking elements 7 are arranged on the entirety of the obturator ring to retain the annular the gasket. The obturator ring is arranged with an upper side 16 and a lower side 17, where the lower side 17 is arranged against the outer surface of the projectile, when the obturator ring is attached to the projectile, and where the upper side seals against the barrel in the ejection device when the projectile is fired from a barrel. The obturator ring is arranged with a front short side 15 and a rear short side 14 where the annular gasket is arranged to the obturator ring.

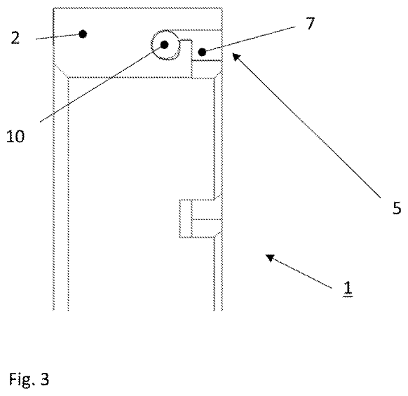

FIG. 3 shows how the locking element 7 is shaped to retain the annular gasket 10 in groove 5. The shaping takes place so that the annular gasket is preferably not pressed by the locking element 7 but is still movably arranged in groove 5 while the locking element 7 prevents the annular gasket 10 from leaving groove 5. The locking element 7 is preferably formed by means of hot forming/melt forming so that the locking element 7 can be deformed without affecting the material properties of the obturator segments.

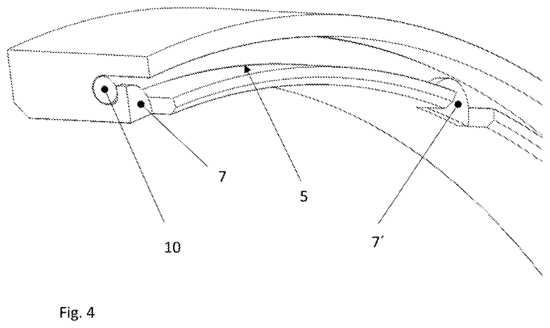

FIG. 4 shows a segment of the obturator ring 1 where it is clearly visible how the annular gasket 10 is arranged in groove 5, where two locking elements 7, 7′ as shown in the figure retain the annular gasket 10 in groove 5.

In the embodiment shown, the locking elements are arranged with 30 degrees of separation, which means that a total of 12 locking elements are arranged on the complete ring, a fact which is not visible in FIG. 4 since only a segment of the obturator ring 1 is shown there.

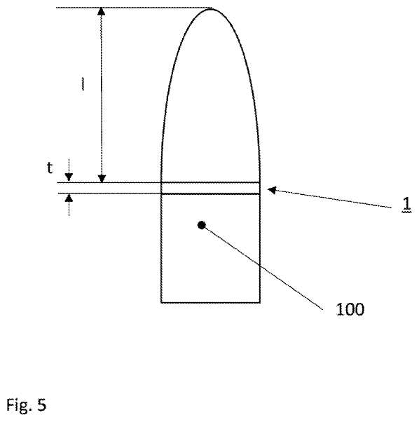

FIG. 5 shows a projectile 100 arranged with an obturator ring 1. The obturator ring is arranged at a position 1, at the forward point of the obturator ring, from the tip of the projectile at between 30%-95% of the total length of the projectile. The width of the obturator ring, t, is between 10 mm-50 mm. The obturator ring is arranged in a groove arranged on the projectile with a depth in the range of 1 mm-10 mm. The thickness of the obturator ring is in the order of 2 mm-11 mm.

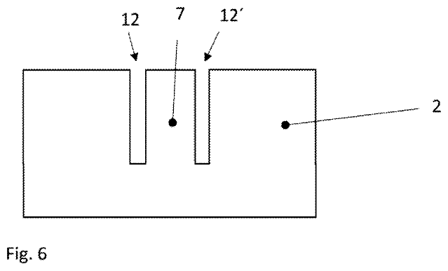

Locking elements 7, 7′ are preferably created by hot forming of goods in the obturator segments 2, 3 provided by the obturator ring 1. FIG. 6 shows an alternative embodiment for how the tongue of a locking element 7 is arranged on an obturator segment 2 by arranging two grooves 12, 12′ on the obturator segment 2. The grooves can be machined or otherwise created in the obturator segment so that locking member 7 can be shaped to retain the annular gasket 10 in groove 5.

A projectile for a grenade launcher is provided with a propellant which, upon initiation, causes the projectile to be propelled out of the barrel. Projectiles for grenade launchers can also be arranged so as to gradually increase the amount of propellant in order to adjust the firing range of the projectile. In this case propellant can be arranged on the projectile, often in the form of horseshoe-shaped/annular charges.

When a projectile is arranged in the barrel, for example when the projectile is arranged at the mouth of a grenade launcher, the projectile will be arranged for launch from the grenade launcher by being moved/placed at the bottom of the grenade launcher's barrel. Depending on the grenade launcher's construction, the propellant in the projectile can be initiated directly when the projectile hits the bottom of the barrel. Alternatively, the grenade launcher can be arranged with a firing pin so that the propellant in the projectile is initiated when the firing pin is activated.

When the propellant burns, gas is generated which, depending on the gas pressure, pushes the projectile through the barrel. The gas pressure that occurs upon ignition of the propellant behind the projectile 100 depends partly on the chemical and physical design of the propellant, but also on the weight of the projectile 100 and the friction that forms between the projectile 100 and the barrel. To prevent the gas pressure from leaking past the projectile, it is important that the projectile seals against the barrel when fired, but the seal should also not be so strong that friction occurs between the projectile and the barrel when fired. Furthermore, the projectile must be able to be arranged to the barrel in a safe and functional way, which is why the projectile must be able to easily move in the barrel when loaded so that the filling gas, such as air, between the projectile and the barrel can be evacuated into a gap between the projectile and the barrel. Preferably, the projectile is thus arranged with a sealing obturator ring which, when loading the projectile, is either not in physical contact with the barrel or has small or limited physical contact with the barrel, while, at the same time, it expands and provides a seal between the projectile and barrel during initiation of the propellant and ejection.

An example of a projectile with an obturator ring is a 60-120 mm grenade launcher designed to be muzzle-loaded into a grenade launcher with a smooth bore barrel.

The invention is not limited to the embodiments specifically shown, but can be varied in different ways within the framework of the claims.

It is understood, for example, that the number, size, material and shape of the elements and details included in the obturator ring are adapted to the weapon system(s) and other design features that are currently available.

It is understood that the above-described projectile designs with an obturator ring can include several different dimensions and projectile types depending on the area of use and barrel width. However, the above refers to the most common grenade types of between approx. 25 mm-200 mm in diameter/caliber, at least as things stand today.

1. Projectile, arranged with an obturator ring, intended to be fired from a weapon system with a barrel, where the obturator ring is outfitted with at least one obturator segment arranged with at least one slot, wherein at least one obturator segment is held together and retained in a projectile by means of an annular gasket arranged for at least one obturator segment.

2. Projectile according to claim 1, wherein at least one obturator segment is arranged with a groove adapted for the annular gasket and that at least two locking elements are arranged so that they retain the annular gasket in the groove.

3. Projectile according to claim 2, wherein the groove is arranged on a rear short side of at least one obturator segment where the annular gasket is arranged.

4. Projectile according to claim 1, wherein slots on at least one obturator segment partial overlap by means of conically shaped contact geometry on at least one slot where a first contact geometry aligns with a second contact geometry.

5. Projectile according to claim 1, wherein the obturator ring comprises two obturator segments.

6. Projectile according to claim 1, wherein the annular gasket is an O-ring made out of a polymer.

7. Projectile according to claim 1, wherein the annular gasket is an annular tension spring made out of metal.

8. Method for manufacturing an obturator ring arranged by at least one obturator segment with at least one slot, wherein
i.) at least one obturator segment is arranged in a ring shape,
ii.) an annular gasket is arranged in a groove arranged in at least one obturator segment where at least one obturator segment individually or together forms an obturator ring,
iii.) a locking element is hot formed on at least one obturator segment for retaining the annular gasket to at least one obturator segment.

9. Method for manufacturing an obturator ring arranged by at least one obturator segment with at least one slot according to claim 8, wherein at least one obturator segment is arranged on a hot forming station to form locking elements.

10. Method for arrangement of an obturator ring comprising a number of obturator segments arranged with an annular gasket on a projectile, wherein:
i.) the obturator ring is arranged on a fixture,
ii.) the fixture with the obturator ring is arranged on projectile,
iii.) the obturator ring is removed from the fixture in a groove arranged on the projectile.
